(19) United States
(12) Patent Application Publication
(10) Pub. No.: US 2014/0065285 A1
(43) Pub. Date: Mar. 6, 2014

(54) Crunchy egg product and manufacturing apparatus and process

(71) Applicant: Ray M. Alden, Raleigh, NC (US)

(72) Inventor: Ray M. Alden, Raleigh, NC (US)

(21) Appl. No.: 13/573,242

(22) Filed: Sep. 4, 2012

(51) Int. Cl. A23L 1/32

(52) U.S. Cl. CPC A23L 1/32
USPC 426/614

(57) ABSTRACT

The invention described herein comprises a crunchy egg product, manufacturing apparatus, and manufacturing processes to produce a desirable consumer product that is nutritious and fulfills a gap in crunchy low carbohydrate snack food product category. The final product comprises a high egg percentage by volume and a low water content by weight, audible fracturing characteristics, and brittleness characteristics. It comprises a low carbohydrate, high protein crunchy snack food for consumption by those on a low carbohydrate diet. Manufacturing steps and apparatuses are described.

### BACKGROUND

1. Field of Invention

This invention relates to a food product manufactured for human consumption. More specifically a crunchy, high protein, low carbohydrate product made primarily from eggs is described. The manufacturing apparatus and manufacturing process are also described.

2. Description of Prior Invention

Since before recorded history, humans have consumed eggs as a food. For thousands of years, eggs have been utilized as an important ingredient in thousands of food recipes. As an ingredient, eggs are often mixed into a batter with other ingredients. For example to make hundreds of types of baked goods, a grain such as wheat is used as a primary ingredient, eggs are mixed in to achieve properties such as cohesiveness, texture, and appearance while sugar is added for taste. In modern day western civilization, much cost and effort is expended by people trying to lose weight or to remain trim. One very common approach is to eat a diet significantly restricted in carbohydrates such as sugars and grains. People on carbohydrate restricted diets typically substitute in more protein and fat than what is considered a traditional diet but these people can and do loose significant weight. Once a consumer starts a low carbohydrate diet, it quickly becomes apparent to them that few crunchy types of low carbohydrate snack foods are available in a conveniently packaged product.

Crunchy snack foods such as potato chips, corn chips, crackers, and cookies all comprise high carbohydrates and sugars and low protein. Thus people whom are on carbohydrate restricted diets very much miss the possibility of snacking on crunchy snack foods. As described herein, a crunchy snack food made primarily from eggs is a good substitute for crunchy snack foods made from carbohydrates and sugars.

### BRIEF SUMMARY

The present invention comprises the ingredients, apparatus, and manufacturing process required to manufacture a crunchy snack food that is low in carbohydrates and is high in protein. Depending upon ingredient proportions, preparation, and cooking duration, the crunchy egg snack food described herein can take the form of a chip, a cracker, a cookie, or a puffed extrusion. The crunchy texture is described in terms of having a low water content, an audible “crack” sound when fractured, and as brittleness as demonstrated in fracture when subjected to even a low angular bend in a Three Point Bend test. During product consumption, the brittleness and sound comprise dimensions known to consumers as “crunchy”.

### OBJECTS AND ADVANTAGES

Accordingly, several objects and advantages of the present invention are apparent. The present invention utilizes eggs as the primary ingredient. Eggs are a well known and accepted form of protein easily metabolized in the human body. Agricultural infrastructure makes eggs readily available in large quantities suitable as a high volume food source. Egg proteins prepared and cooked as described herein form a crunchy product suitable for packaging and distribution as a long shelf life snack product. A large segment of the population is on a carbohydrate restricted diet and looking for products having the attributes of common snack foods including crunchy texture, fracturing brittleness, fracturing sound, product cohesiveness, customary tastes such as salt, cheese, and onion and hand or mouth sized dimensions suitable for eating with one hand while driving or on the sofa without any fuss or mess.

Further objects and advantages will become apparent from the enclosed figures and specifications.

### DRAWING FIGURES

FIG. 1 illustrates steps or modules in a manufacturing process to produce crunchy egg products of the present invention.

FIG. 2a illustrates an oiling the cookware step.

FIG. 2b illustrates a deposition of raw egg batter step.

FIG. 2c illustrates a solidifying of egg cooking step.

FIG. 2d illustrates a solidified egg cutting step.

FIG. 2e illustrates an ingredient additive step.

FIG. 2f illustrates a crisping and drying cooking step.

FIG. 3a illustrates a physical size dimension of a finished crunchy egg product.

FIG. 3b illustrates a final product texture test setup.

FIG. 3c illustrates a final product texture test completion.

FIG. 4a illustrates an alternate raw batter deposition into a mold step.

FIG. 4b illustrates extrusion deposition of whipped raw egg batter.

FIG. 4c illustrates an alternate crisping and drying cooking step.

FIG. 5a illustrates a two crunchy egg product shapes and texture tests thereof.

FIG. 5b illustrates a tortilla shaped solidified egg product before and after crisping in the microwave.

FIG. 5c illustrates a variety of larger diameter hand sized egg products.

### DETAILED DESCRIPTION OF THE INVENTION

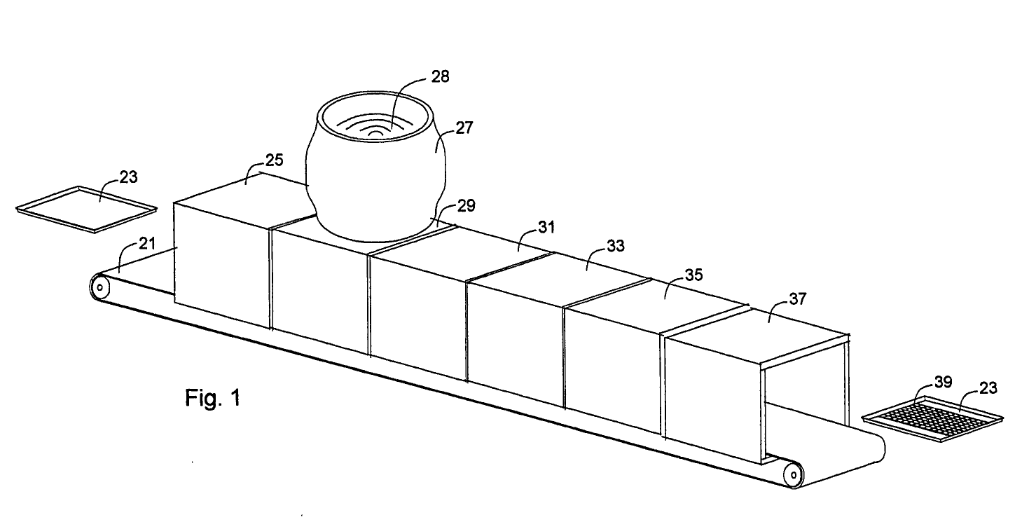

FIG. 1 illustrates steps in a manufacturing process to produce crunchy egg products of the present invention. A conveyor belt apparatus 21 drives product through manufacturing steps wherein on one end of the conveyor belt apparatus a cookware 23 is put in. The conveyor belt being suitable for use in a microwave and in an oven such as are available from commercial food manufacturing equipment suppliers listed in the Thomas Register of Manufacturers. The cookware being suitable for microwave use, baking use, and capable of withstanding the rigors of a continuous manufacturing process. The cookware can take the form of discrete cooking plate type elements as illustrated herein or wherein the surface of the conveyor belt is itself the cookware. During the manufacturing process, the cookware 23 advances on the conveyor belt apparatus 21 through a series of steps within manufacturing modules each engineered to perform a manufacturing process step. In the illustration each module is depicted as being approximately the same size however in practice, the respective module lengths and dimensions vary depending upon what process step is being performed and how much time a respective manufacturing process step takes. Each of the modules described are readily available from multiple suppliers specializing in industrial engineering systems for food cooking and preparation.

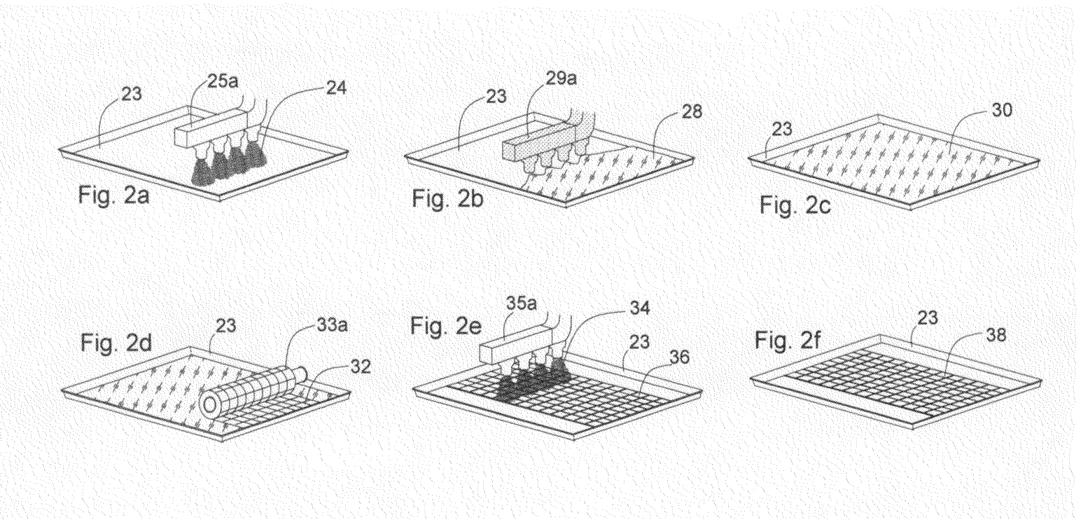

The first process step is performed on the cookware 23 itself in an oil deposition module 25 where the cooking surface is oiled as is further described and illustrated in FIG. 2a.

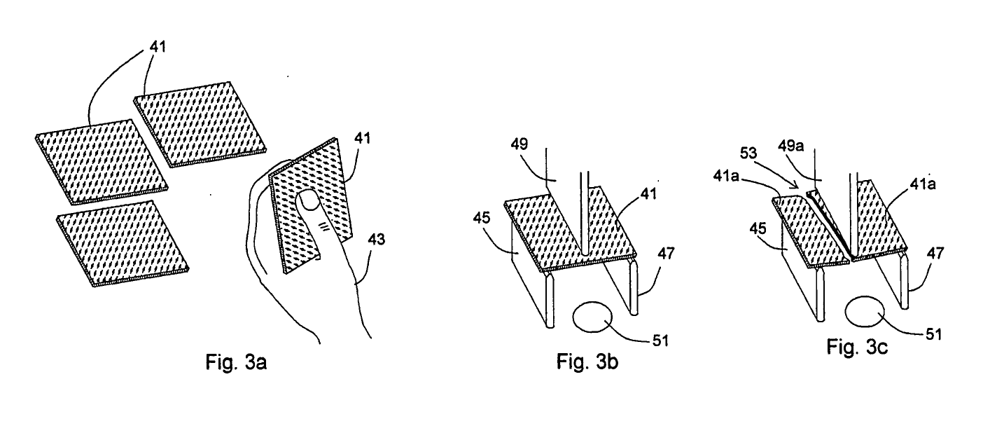

The second process step is an ingredient mixing module 27 step. Commercial grade food mixers are well known and readily available. For a crunchy egg cracker product of FIGS. 2a through 3c, ingredients are put into the ingredient mixing module in the following proportions (scaled up to the size of the manufacturing operation):

half cup of liquid egg white

two tablespoons of dried egg white

half tablespoon of dried onion soup (salt, pepper, onion, garlic, flavoring, coloring)

one tablespoon of dried onion

quarter teaspoon of baking powder

two tablespoons of dried butter milk

Note that by volume the above ingredients comprise more than 50% egg by volume and by weight. Water can be substituted for liquid egg white in which case egg will comprise a lesser percentage of inputs. For the purpose of comparing the ingredients herein to ingredients of the prior art, the product herein is greater than 50% egg by volume after the manufacturing process is complete. During the heating processes described herein egg ingredients expand including the dried egg white which absorbs water and expands dramatically when microwave heated for example (increasing the product's volume and decreasing its density) whereas the other (non-egg) ingredients generally do not substantially increase in volume during the manufacturing steps. (Baking powder and yeast are examples of ingredients that can also contribute to product volume expansion.) During the solidifying step below, the onion soup causes the solidified egg to be an off white beige color, food coloring can be added to the above ingredients to achieve other desired colors.

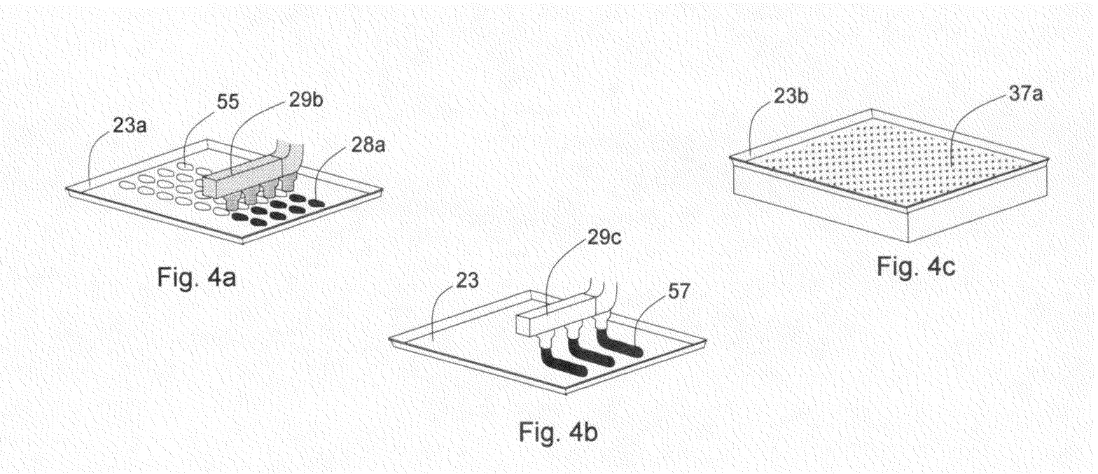

Within the ingredient mixing module 27 the ingredients are mixed through an automated stirring activity to form a raw egg batter 28 that has a consistency suitable for gravity feed or pumping and deposition, pouring, or extrusion as described subsequently herein. Within the raw egg ingredient deposition module 29 the raw egg batter is deposited onto the cookware 23 as illustrated and described in FIG. 2b, FIG. 4a, and FIG. 4b. Once the cookware 23 has received its intended amount of raw egg batter it advances to a microwave egg solidification module 31 step as in FIG. 2c where microwave energy transforms the batter to a solidified consistency but still having a high water content, properties similar to an egg one would cook for breakfast at home wherein the egg is a solid but still has high water content. Microwave apparatuses for commercial food manufacturing are available from multiple suppliers. Once the egg is solidified it advances to a cutting module 33 step where it is cut into desired shapes and sizes as illustrated and described in FIG. 2d. After cutting, the cookware 23 advances to an ingredient additive module 35 step illustrated and described in FIG. 2e where additional ingredients are deposited onto the surface of the solidified egg work in progress. This additive step can be eliminated if desired. The cookware 23 advances to a crisping module 37 step where it is transformed from a high moisture solidified state to a crispy state as is illustrated in FIG. 2F and FIG. 4C. In FIG. 2F, the crisping module comprises a baking oven set to 350 degrees, such baking ovens are readily available from commercial suppliers. After moving through the modules and manufacturing process steps therein, a crunchy egg product output 39 is forthcoming on the cookware 23.

Following is a partial list of ingredients that have been utilized in differing proportions to produce crunchy egg products similar to those described herein; whole egg, egg white, dried egg, dried egg white, water, onion, garlic, salt, pepper, cheese, taco flavoring, barbecue flavoring, dried buttermilk, oil, fat, shortening, yeast, baking soda, and baking power. Many other flavoring and coloring ingredients are possible.

Carbohydrates from the egg ingredient are as follows

Dried Egg white—8.2% of calories come from carbohydrates

Dried Egg white, glucose reduced—4.8% of calories come from carbohydrates

Dried Whole Egg—3.3% of calories come from carbohydrates

Dried Whole Egg, glucose reduced—1.5% of calories come from carbohydrates

Whole egg—1.8% of calories come from carbohydrates

FIG. 2a illustrates an oiling the cookware step. In this manufacturing step, an oil deposition apparatus 25a sprays cooking oil 24 onto the surface of the cookware 23. Canola oil is suitable and flavor ingredients can be added as desired. Programmable ingredient deposition sprayer assemblies suitable for this purpose are available from commercial food manufacturing equipment suppliers. They have programmable pumps and valves that open and close at timed intervals to deposit a desired amount of fluid onto a targeted surface within a defined amount of time. The same oil deposition apparatus 25a can be used in FIGS. 2e with slight adjustments depending upon ingredients sprayed.

FIG. 2b illustrates a deposition of raw egg batter step. The raw egg batter 28 from the ingredient mixing module 27 has semi-liquid consistency to be pumped from the ingredient mixing module to a raw egg deposition apparatus 29a which deposits it onto the oiled cookware 23.

Programmable batter deposition nozzle assemblies suitable for the egg deposition apparatus 29a are available from commercial food manufacturing equipment suppliers. They have programmable pumps and valves that open and close at timed intervals to deposit a specific amount of batter material onto a cooking surface or into a cooking oil fryer within a specified amount of time. The same raw egg deposition apparatus 29a can be used in FIGS. 4a and 4b with slight adjustments.

FIG. 2c illustrates a solidifying of egg cooking step. Inside the egg solidification module 31 a microwave (not shown) transfers energy into the egg which enters as a raw batter and exits this step as a solidified egg 30 having the appearance and consistency of a cooked egg, solid yet with a high water content. For the above crunchy egg cracker recipe, a raw egg layer two mm thick enters the microwave solidifier and a solid egg product exits the microwave four mm thick after forty five seconds. The solidified egg takes on a pleasant beige color due to the egg white solidifying with the coloring from the dried onion soup ingredients. The moisture content of solidified egg makes it a suitable surface for receiving sprinkled on flavorings (not illustrated) such as dried cheese, salt, pepper etc. Flavorings sprinkled onto solidified eggs adhere well throughout the remaining manufacturing steps and add visual appeal to the final product.

FIG. 2d illustrates a solidified egg cutting step. Once the egg is solidified it can easily be cut into pieces. The cookware 23 advances to the cutting module 33 where a solidified egg cutting apparatus 33a roles across the cookware 23 cutting solidified egg into pieces one and a half inches by one and a half inches by four mm thick. The solidified cutting apparatus is a six inch diameter cylindrical stainless steel molded fabrication having a number of edges around the external circumference each spaced one and a half inches apart and a number of edges running the cylinder length spaced one and a half inches apart. The solidified egg cutting apparatus 33a creates a plurality of cut egg solids 32 that remain in the cookware 23.

FIG. 2e illustrates an additive step. An additive application apparatus 35a is similar to the oil deposition apparatus 25a of FIG. 2a with the programmable pumps and valves programmed to open and close at timed intervals to deposit a desired amount of fluid onto the targeted surface within a defined amount of time. In this step, an additive 34 such as canola cooking oil is sprayed onto the egg product work in progress. Flavor ingredients such as salt and garlic can be also be added as desired. Also food coloring or other features can be added to enhance appearance. Ingredients can also be sprinkled (not shown) onto the egg work in progress.

FIG. 2f illustrates a crisping and drying cooking step. The cookware 23 containing a baking solidified egg 38 enters the crisping module 37 (the 350 degree oven) and is cooked for five to ten minutes. During cooking, portions of the product will change from an off white color to a tan or brown color. When thirty percent of the product transitions to the tan or brown color, the product is fully cooked and dried and is removed from heat. This yields a product very low in water content (two percent moisture by weight) that is crispy and crunchy according to Three Point Bend tests as later described. After moving through the steps in FIGS. 2a through 2f, a crunchy egg product output 39 of FIG. 1 is forthcoming on the cookware 23.

A programmable moisture sensor such as from MoistureTech.com can be added to any step during the manufacturing process to ensure moisture meets targeted standards.

While the ideal crunchiness is achieve at approximately two percent moisture content, in practice the final product has some variability between zero percent and ten percent moisture content by weight.

The above egg finished product is described as over fifty percent egg content by volume, as below a crunchy egg product can be manufactured with nearly one hundred percent egg content by volume. Also as below a puffed crunchy egg product contains a high volume of air; for the purpose of measuring contents by volume, air content is not considered. Also given the binding properties of proteins within eggs, a crunchy product can be produced using the processes and ingredients described herein wherein the final product has thirty percent egg content by volume.

FIG. 3a illustrates a physical size dimension of a finished crunchy egg product. A finished crunchy egg cracker product 41 is easily held by a human hand 43 as is common with nearly all crunchy snack foods currently consumed by consumers. Multiple product units (individual crackers) are packaged together in a bag similar to potato chips and corn tortilla chips then easily grasped and consumed with one hand. Consumers often eat snack foods while doing other things such as driving a vehicle, using electronic devices, or watching TV. Such products need to be easily manipulated and consumable in bite sized pieces such as is possible with the finished crunchy egg product 41.

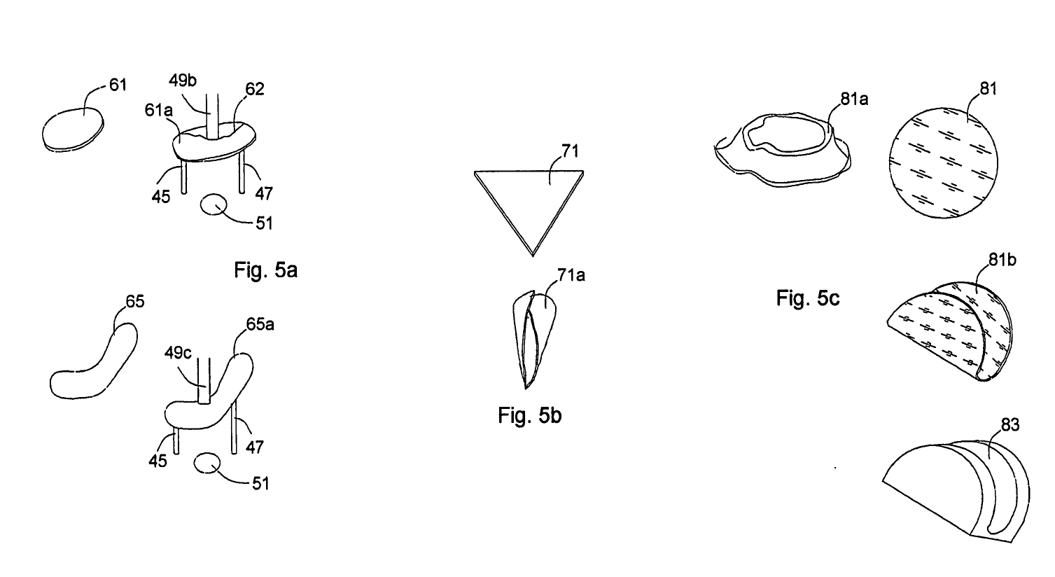

FIG. 3b illustrates a final product texture test setup. Food Technology Corporation supplies the Three Point Bend test apparatus illustrated in FIGS. 3b, 3c, and 5a. It and similar products are widely used to study a product's crunchiness and other texture attributes. Bend profile, audible sound, and water content are three characteristics that can be used to compare the present crunchy egg product with prior art crunchy products such as potato chips, corn tortilla chips, wheat crackers and wheat cookies. Bend profile, audible sound, and water content are three characteristics that can be used to contrast the present crunchy egg product with prior art baked and fried products containing egg. The finished crunchy egg cracker product 41 is placed to rest upon the Three Point Bend test apparatus including upon a first support 45 and a second support 47. Note that the crunchy egg cracker product is rigid and has no perceivable bend in the middle caused by gravity. A plunger 49 is above the surface of the finished crunchy egg cracker product 41. A microphone 51 is in close proximity to the test so as to sense/record the audible sound of the test in FIG. 3c.

FIG. 3c illustrates a final product texture test completion. During the test the plunger is slowly actuated downward as an actuated plunger 49a to come in contact with the finished crunchy egg product 41 and continues slowly downward. When a maximum angular bend is exerted onto the cracker from the actuated plunger 49a the finished crunchy egg product 41 snaps into two (or more) pieces of a fractured finished crunchy egg cracker product 41a separated by an egg product fracture 53. The fracture of the cracker is audible to a human ear (not shown) and sensed and recorded by the microphone. The current product is similar to prior art chip, and cracker snack foods in that when fractured it has an audible “crack” sound. Additionally, The current product is similar to prior art chip and cracker products in that its brittle nature allows for less than a two degree angular bend before a fracture appears. The Three Point Bend test contrasts the prior art high egg composition products that do not fracture at less than two degrees of angular bend. The Three Point Bend test contrasts the prior art high egg composition products that do not produce an audible crack sound when fractured under angular stress. Depending upon manufacturing quality controls, some product variability can occur whereby an angular bend up to ten degrees may be demonstrated before fracture in the Three Point Bend test.

FIG. 4a illustrates an alternate raw batter deposition step. An alternate cookware 23a is manufactured of a material suitable for microwave use and oven use and comprises a series of depressions including a depression mold 55 suitable for receiving raw egg depositions of individual chips. Once the alternate cookware 23a is oiled similarly to FIG. 2a, an alternate raw egg deposition apparatus 29b includes valves and pumps that are programmed to receive the raw egg batter 28 from the ingredient mixing module 27 and deposit it into the depressions such as discrete raw egg batter deposit 28a.

Whereas the ingredients and steps described above under FIGS. 1 through 3c relate to manufacturing a crunchy egg cracker product, the ingredients and steps of FIG. 4a are modified to produce a thin bisected egg oval shaped finished crunchy egg chip product 61 further described under FIG. 5a below. Ingredients are the same as above except that one tablespoon of dried egg white is utilized instead of two. For the crunchy egg chip recipe, a raw egg layer one mm thick enters the microwave solidifier and a crispy egg product exits the microwave 2 mm thick after 90 seconds. The cutting step of FIG. 2d is not needed, if desired the additive step of FIG. 2e can be utilized to add an oil, flavor or color dimension. The baking step of FIG. 2f is not needed since the crisping is achieved by a longer microwave heating cycle. The finished chip product is allowed to change to a tan or brown color in the microwave but if it turns black, the taste will be too strong for most consumers. A programmable optic sensor system can be added to keep the microwave on so as to ensure the product transitions to a good tan/brown color but to turn the microwave off prior to any transition to a black color. The brittle texture of the chip product from FIG. 4a is characterized under the Three Point Bend test in FIG. 5a. The finished crunchy egg chip described in FIG. 4a contains thirty five percent egg by volume.

FIG. 4b illustrates extrusion deposition of whipped raw egg batter. Whereas the ingredients and steps described above under FIGS. 1 through 3c relate to manufacturing a crunchy cracker product, the ingredients and steps of FIG. 4b are modified to produce a crunchy egg puff product 65 further described under FIG. 5a below.

The puffed egg product takes advantage of the changes that raw eggs undergo when whipped, thus during mixing the raw egg batter is whipped instead of being stirred also the initial ingredients are changed to optimize the whipping consistency change. The ingredient mixing module 27 whips ingredients in the following proportions, a half cup of liquid egg white and two tablespoons of dried egg white. After whipping, the raw egg batter is heavily aerated and clings to an upside down spoon, the whipping essentially mixes air as an ingredient into the batter. A raw egg extrusion deposition apparatus 29c deposits the whipped batter onto the cookware 23 as a raw egg extrusion 57. The raw egg extrusion deposition apparatus 29c including (as previously discussed) valves and pumps that are computer programmable to deposit three and a half mm diameter three inch long light airy cylinders onto the cookware 23 which after cooking two minutes in the microwave will form crunchy seven mm diameter cylinders distorted into random shapes.

The crunchy egg puff product receives the additive step of FIG. 2e to add salt, flavor or color dimension except the cooked egg puffs are tumbled in a bath of dry flavorings such as dried cheese that is common in puffed snack foods. Alternately, the puffed raw egg can first be solidified then sprinkled with cheese flavoring, then microwaved to crispness. In either case, a cheese flavored egg puff that is over seventy five percent egg by volume is the final crunchy egg product. The baking step of FIG. 2f is not needed since the crisping is achieved in the microwave. In the microwave, the puffed crunchy egg product can be cooked to change to a tan or brown color but if it turns black, the taste will be too strong for most consumers. As above, a programmable optic sensor system can be added to keep the microwave on so as to ensure the product transitions to a good tan/brown color but to turn the microwave off prior to any transition to a black color. The brittle texture of the puffed egg product from FIG. 4b is characterized under the Three Point Bend test in FIG. 5a. A final product moisture content of two percent is achieved but can vary between zero percent and ten percent moisture by weight.

FIG. 4c illustrates an alternate crisping and drying cooking step. As discussed above, the product can be solidified, cooked and crisped in a single step or in multiple steps to optimize quality and desirable characteristics. Use of a microwave and an oven have been described above. A flyer 23b is a good alternative mechanism to drive water out of the product and cause it to crispin to achieve the desired brittle texture, moisture, sound, and fracture characteristics that can be verified in a Three Point Bend test. Frying can be substituted for baking or for microwaving wherein hot oil comprises an alternate crisping module 37a. Fryers are available from commercial food manufacturing equipment suppliers. Fried products can cause the solidifying, heating, drying, and crisping transitions discussed above so as to achieve the tan/brown color, audible sound, angular bend brittleness, and fracture characteristics that define a crunchy snack food as discussed in FIGS. 3a, 3b, and 5a.

FIG. 5a illustrates the crunchy egg product shapes and texture of the products of FIGS. 4a and 4b together with tests thereof. During a crunchy egg chip test first alternate actuated plunger 49b is slowly actuated downward to come in contact with the egg shaped finished crunchy egg chip product 61 and continues slowly downward until it creates a chip fracture 62 in fractured egg shaped chip 61a. When a maximum angular bend is exerted onto the chip from the first alternate actuated plunger 49b the egg shaped finished crunchy egg chip product 61 snaps into two (or more) pieces. The fracture of the chip is audible to a human ear (not shown) and sensed and recorded by the microphone. The current chip product is similar to prior art chip, and cracker snack foods in that when fractured it has an audible “crack” sound. Additionally, The current product is similar to prior art chip and cracker products in that its brittle nature allows for less than a two degree angular bend before a fracture appears. The Three Point Bend test contrasts the prior art high egg composition products that do not fracture at less than two degrees of angular bend. The Three Point Bend test contrasts the prior art high egg composition products that do not produce an audible crack sound when fractured under angular stress. Note that some product variation can occur wherein the product may fracture within an angular bend range between zero degrees to ten degrees.

During a puffed egg product test a puff test second alternate actuated plunger 49c is slowly actuated downward to come in contact with the crunchy egg puff product 65 and continues slowly downward. Whereas in the above Three Point Bend tests, the product broke into two or more pieces, the fractured crunchy egg puff 65a crushes with an audible cracking sound but doesn't initially break into pieces. When a maximum angular bend is exerted onto the surface of the puff its top surface fractures but the entire product doesn't initially fracture. The wall crush fracture is audible to a human ear (not shown) and sensed and recorded by the microphone. The current puff product is similar to prior art puffed snack foods in that when its surface is fractured it has an audible “crack” sound. Additionally, the current product is similar to prior art chip and cracker products in that its brittle nature allows for less than two degrees of angular bend before a wall fracture occurs. The Three Point Bend test contrasts the prior art high egg composition products that do not fracture at two degrees or less angular bend. The Three Point Bend test contrasts the prior art high egg composition products that do not produce an audible crack sound when fractured under angular stress. While the wall fracture will consistent occur with less than two degrees of angular bend product variability creates the possibility that fracture occurs between zero degrees and ten degrees of angular bend. Moisture content of the final crunchy puffed egg product is two percent but a variability is possible such that moisture is between zero percent and ten percent in the final product.

FIG. 5b illustrates a tortilla chip shaped solidified egg product before and after crisping in the microwave. Ingredients are combined as above in proportion to the following, a half cup of water and two tablespoons of dried egg white. Oil is deposited on cookware as in FIG. 2a. As in FIG. 2b, the raw egg batter is deposited onto the cookware but in a one mm think layer and then solidified in the microwave for 45 seconds as in FIG. 2c then cut as in FIG. 2d except in triangular shapes into a tortilla chip shaped solidified egg 71. Powdered flavorings can be sprinkled onto the chips in a flavoring step (not shown) as is common in baked and confectionary product manufacturing. The powdered flavoring such as dried cheese, salt, garlic, and pepper will stick to the moist solidified egg as it then goes through the crisping process in the microwave. The solidified egg then enters the microwave for another 45 seconds for crisping. A microwave crisped egg finished product 71a is produced. The action of the egg in the microwave causes it to contort in shape and harden in a curled shape as illustrated in FIG. 5b. The final crunchy egg product is ninety percent egg by volume, contains two percent moisture, will fracture with two degrees or less angular bend and upon fracture produces an audible sound.

FIG. 5c illustrates a variety of larger diameter egg products. A round tortilla solidified egg 81 measures eight inches in diameter. When deposited in a 8 inch diameter depression and cooked in the processes described in FIGS. 2a through 2c (but not put though any crisping step) a cooked egg soft tortilla is produced that can be wrapped around food as is customary with soft tortillas. If the round tortilla solidified egg 81 is placed in a taco shaped mold 83 and baked as in FIG. 2f, a taco shaped crunchy egg product 81b is produced. Alternately, if the round tortilla solidified egg 81 continues to cook within the microwave for four minutes or until it begins to brown, a microwave crisped larger product 81a is produced which is very crunchy and suitable for functioning as a large taco shell bowl. In the microwave the egg expands, rises, and contorts into a wide range of bowl like shapes. This expanding of the eggs in a microwave makes it suitable for putting into a mold and heating in the microwave until it crispins, the finished crunchy egg product will have the shape of the mold as in FIG. 5c and is FIG. 4a.

Throughout the above specifications, crunchy texture is characterized by certain definable attributes such as audible sound during fracture, angular bend limit prior to fracture (brittleness), and low water content. These differentiate a crunchy egg product from prior art products incorporating eggs as a primary ingredient.

### OPERATION OF THE INVENTION

Operation of the invention has been discussed under the above under the Detailed Description of the Invention heading and is not repeated here to avoid redundancy.

### CONCLUSION, RAMIFICATIONS, AND SCOPE

Thus the reader will see that the crunchy egg product, manufacturing apparatus, and manufacturing processes of this invention provides a well defined and desirable consumer product that is nutritious and fulfills a gap in crunchy low carbohydrate snack food product category.

While the above description describes many specifications, these should not be construed as limitations on the scope of the invention, but rather as an exemplification of a preferred embodiment thereof. Many other variations are possible.

The egg ingredient herein can comprise whole egg or any egg product derived there from including glucose reduced dried egg or glucose reduced dried egg white.

It should be noted that the phrase “raw egg batter” is used herein to distinguish between the batter, solidified egg, and crisped egg. In fact the egg portion of the batter may consist of only dried egg or dried egg white in which case no literal raw egg is utilized.

Raw egg deposition or batter deposition means placing the batter into a position for cooking for example; depositing batter onto a surface, extruding batter onto a surface, depositing batter into a fryer, extruding batter into a fryer, and extruding batter into air that is then heated or microwaved.

The term solidifying is used herein to mean transitioning of the batter from a liquid or foam state to a high moisture content solid state, solidifying is a cooking process.

The term crisping is used here to mean transitioning of the solidified egg into a low moisture crunchy product. Crisping is a cooking process and/or a drying process.

Ingredients are mixed together herein, whipping is a specialized form of mixing that may for example mean mixing air or other gases into the raw egg or the batter to achieve certain properties suitable for the crunchy puffed egg product for example.

Spraying onto the solidified egg is described as a color, flavoring, texture, or oil additive step. Other additive steps are possible such as sprinkling onto the solidified egg, and tumbling the solidified egg in a bath of dried or moist flavorings. Similarly the batter can receive additives through spraying, sprinkling, and tumbling and the crisped egg can receive additives through spraying, sprinkling, and tumbling.

What is claimed:

1) A crunchy egg product comprising;
egg,
wherein said egg undergoes a cooking process,
wherein by volume said final crunchy egg product contains more than thirty percent egg,
wherein by weight said final crunchy egg product contains less than ten percent water
wherein said crunchy egg product has a crunchy attribute that is characterized by one selected from the group consisting of when said crunchy egg product is fractured an audible cracking sound is produced, and when said crunchy egg product is subjected to a three point bend test it fractures after bending ten degrees or less.

2) The crunchy egg product of claim 1 wherein said, when said crunchy egg product is fractured an audible cracking sound is produced, attribute is selected and wherein when said crunchy egg product is subjected to a three point bend test it fractures after bending ten degrees or less.

3) The crunchy egg product of claim 1 wherein a single unit of said crunchy egg product is suitable in size for grasping and holding with fingers during consumption.

4) The crunchy egg product of claim 1 wherein prior to cooking said egg comprises a water reduced egg product.

5) The crunchy egg product of claim 1 wherein prior to cooking said egg comprises dried egg.

6) The crunchy egg product of claim 1 wherein said crunchy egg product further comprises at least one ingredient selected from the group consisting of whole egg, egg white, dried egg, dried egg white, water, air, coloring, onion, garlic, salt, pepper, cheese, taco flavoring, barbecue flavoring, milk, oil, fat, shortening, yeast, and baking power.

7) The crunchy egg product of claim 6 wherein said ingredient is added at a time selected from the group consisting of, added to be part of a mixture prior to cooking, added after a solidification step, and added after a crisping step.

8) The crunchy egg product of claim 6 wherein said ingredient is incorporated into the product by a process selected from the group consisting of mixing, whipping, spraying, sprinkling, and tumbling.

9) The crunchy egg product of claim 1 wherein said cooking process comprises one selected from the group consisting of microwaving, flying, and baking.

10) The crunchy egg product of claim 1 wherein a drying process is performed and in a sequence selected from the group consisting of; said cooking process is first performed then said drying process, said drying process is first performed then said cooking process, and said cooking and said drying processes are performed concurrently.

11) The crunchy egg product of claim 1 wherein said product first undergoes a solidification step, then a cutting step, then a drying step.

12) The crunchy egg product of claim 1 wherein prior to cooking said egg is extruded to produce a desired product shape characteristic.

13) The crunchy egg product of claim 1 wherein said cooking occurs in a mold to produce a desired product shape characteristic.

14) The crunchy egg product of claim 1 wherein prior to cooking said egg is poured to produce a desired product shape characteristic.

15) The crunchy egg product of claim 1 wherein its manufacturing process comprises the steps of;
Providing cookware,
Oiling said cookware,
Deposition of ingredients onto cookware,
Solidification,
Cutting,
and drying.

16) The crunchy egg product of claim 1 wherein a fracture consists of one selected from the group consisting of a crack that penetrates through the thickness of said product, and a crack that penetrates the surface of said product.
